(19) United States
(12) Patent Application Publication
(10) Pub. No.: US 2006/0182571 A1
(43) Pub. Date: Aug. 17, 2006

(54) Game lifting device

(76) Inventor: Rex M. Hightower, Minden, LA (US)

Correspondence Address: John M. Harrison, 2139 E. Bert Kouns, Shreveport, LA, 71105, US

(21) Appl. No.: 11/286,904

(22) Filed: Nov. 23, 2005

Related U.S. Application Data
(60) Provisional application No. 60/631,255, filed on Nov. 29, 2004.
(60) Provisional application No. 60/671,838, filed on Apr. 18, 2005.

(51) Int. Cl. B60P 3/04

(52) U.S. Cl. 414/466

(57) ABSTRACT

A game lifting device for attachment to a vehicle such as an all-terrain vehicle, a pickup truck and the like, which device includes a base or adaptor frame fitted with a pair of pivot arms for pivotally attaching the adaptor frame to a vehicle. In a first embodiment an upper frame is upward-standing from the adaptor frame and has a bend therein, such that the upper frame extends upwardly and forwardly of the adaptor frame and a pivoting frame is pivotally attached to the free extending end of the adaptor frame for receiving a load, pivoting upwardly and rearwardly toward the upper frame and securing the load between the pivoting frame and the upper frame on the adaptor frame. A keeper line may be secured to the pivoting frame and the upper frame or adaptor frame for securing the load while the adaptor frame is pivoted upwardly by operation of a winch line and winch mechanism, into a transportation configuration. In another embodiment a removable boom leg is upward-standing from the adaptor frame and has a lifting arm. A winch line extends through a roller system on the adaptor frame, the boom leg and the lifting arm for receiving and lifting a load and securing the load forwardly of the adaptor frame. An auxiliary stay may be secured to the boom leg and the all-terrain vehicle for securing the boom and the load while the load is raised by operation of the winch and winch line.

### CROSS-REFERENCE TO RELATED APPLICATIONS

This application claims the benefit of and incorporates by reference prior filed copending U.S. Provisional Application Ser. Nos. 60/631,255, filed Nov. 29, 2004, and 60/671,838, filed Apr. 18, 2005.

### SUMMARY OF THE INVENTION

This invention relates to devices for lifting and transporting loads such as game carcasses and more particularly, to a game lifting device which is characterized in a preferred embodiment by a base or adaptor frame fitted with a pair of pivot arms for pivotal attachment to a winch-equipped vehicle such as a pickup truck or an all-terrain vehicle (ATV), an upper frame extending upwardly and forwardly from the adaptor frame and a pivoting frame pivotally attached to the extending end of the adaptor frame. The pivoting frame is designed to selectively open substantially extensively with the adaptor frame for loading purposes and to pivot upwardly and rearwardly toward the upper frame to secure the load. Accordingly, the pivot frame and adaptor frame are designed to receive a load such as a game carcass when the device is lowered and the pivoting frame is easily pivoted toward the upper frame for securing the load for lifting and transportation purposes. In a preferred embodiment the pivot arms are generally L-shaped and are removably and pivotally attached to the vehicle, typically at a pivot arm bracket, the adaptor frame is removably attached to the pivot arms and the upper and pivoting frames are removably attached to the adaptor frame, for ease in maintenance and cleaning. In another preferred embodiment of the invention a flexible keeper line is provided with a pair of keeper hooks for attachment to the pivoting frame and the adaptor frame or upper frame and securing the load in position between the pivoting frame and the upper frame during lifting and transportation.

In a most preferred aspect of this embodiment of the invention the game lifting device is attached to a pivot arm bracket mounted on the front end of an all-terrain vehicle (ATV) fitted with an electric winch and winch cable, such that the winch cable may be extended, removably hooked or otherwise attached to the adaptor frame and the adaptor frame then raised and lowered responsive to pivoting of the pivot arms, by operation of the electric winch. In another preferred embodiment the winch cable is extended from the winch and through a pulley attached to an adaptor frame to facilitate ease of operation of the winch cable during raising and lowering of the game lifting device.

In another embodiment of the invention a boom extends upwardly and removably from a boom mount on the adaptor frame and a lifting arm is attached to the extending end of the boom. A winch line extends from a vehicle winch in one configuration and through a pulley system provided on the adaptor frame, boom and lifting arm. The boom and lifting arm are designed to lift and support a load such as a game carcass when the winch line is lowered and attached to the load and securing the load, for typically dressing and transportation purposes. In a preferred embodiment the pivot arms are generally L-shaped and are removably and pivotally attached to a pivot arm bracket on the vehicle, typically rearwardly of a positioning frame and the adaptor frame is typically removably attached to the pivot arms, while the boom leg of the boom is also typically removably attached to the adaptor frame for ease in assembly, disassembly, maintenance and cleaning of the device. In a preferred aspect of this embodiment of the invention an auxiliary stay having a tensioning clamp is attached to the boom leg and the all-terrain vehicle for stabilizing the boom and lifting arm in functional position and securing the load forwardly of the adaptor frame and the boom leg during lifting, dressing and/or transportation.

In a most preferred aspect of this embodiment of the invention the game lifting device is attached to a pivot arm bracket mounted on the front end of an all-terrain vehicle (ATV) fitted with an electric winch and winch cable, such that the winch cable may be extended around a pulley attached to the adaptor frame and then directed to the boom leg and lifting arm by operation of another pulley system, wherein the load is raised and lowered responsive to operation of the electric winch. Alternatively, the winch cable of a hand-operated boom winch mounted on the boom leg is extended from the boom winch and through the pulley system attached to the boom leg and the lifting arm to facilitate operation of the boom winch cable by hand for raising and lowering of the game carcass or other load from the lifting arm. In yet another embodiment a frame leg is adjustably carried by a positioning frame bolted to the vehicle to prevent the front end of the ATV from depressing excessively when a load is applied to the boom and lifting arm.

### BRIEF DESCRIPTION OF THE DRAWINGS

The invention will be better understood by reference to the accompanying drawings, wherein:

FIG. 1 is a perspective view of the front end of an all-terrain vehicle, with a preferred embodiment of the game lifting device of this invention attached thereto and deployed in partially raised configuration by operation of an electric winch;

FIG. 2 is a perspective view of the all-terrain vehicle and game lifting device illustrated in FIG. 1, more particularly illustrating winch-operated lowering of the base or adaptor frame, upper frame and pivoting frame components in concert and extension of the pivoting frame along the longitudinal axis of the adaptor frame to receive a load such as a game carcass;

FIG. 3 is a side view of the all-terrain vehicle illustrated in FIG. 1, more particularly illustrating the game lifting device deployed in partially raised configuration by operation of the winch;

FIG. 4 is a side view of the all-terrain vehicle illustrated in FIG. 2, with the pivoting frame pivoted upwardly toward the upper frame by operation of the winch to engage and carry a load;

FIG. 5 is an exploded view of the all-terrain vehicle winch, winch line and winch frame assembly, along with the game lifting device pivot arms and base frame elements; and

FIG. 6 is an exploded view of the game lifting device, including the adaptor frame, upper frame and pivoting frame elements.

FIG. 7 is a perspective view of the front end of an all-terrain vehicle (illustrated in phantom) with an alternative embodiment of the game lifting device of this invention removably attached thereto;

FIG. 8 is a perspective, partially exploded view of the all-terrain vehicle and game lifting device illustrated in FIG. 7;

FIG. 9 is a side view of the all-terrain vehicle and game lifting device illustrated in FIG. 1, more particularly illustrating operation of the winch and ATV winch cable;

FIG. 10 is a perspective view of the all-terrain vehicle illustrated in FIG. 7, with the game lifting device tilted forwardly of the all-terrain vehicle; and

FIG. 11 is an exploded view of the game lifting device, including the pivot arms, adaptor frame, boom leg and lifting arm elements.

### DESCRIPTION OF THE PREFERRED EMBODIMENTS

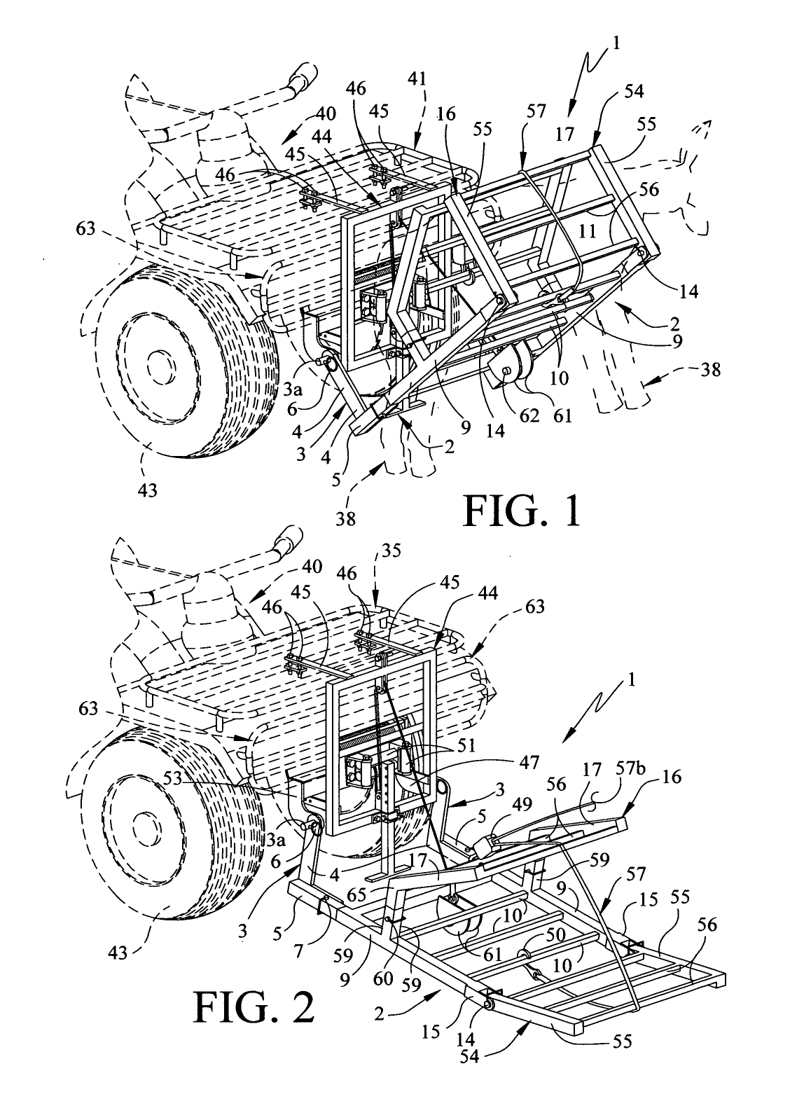

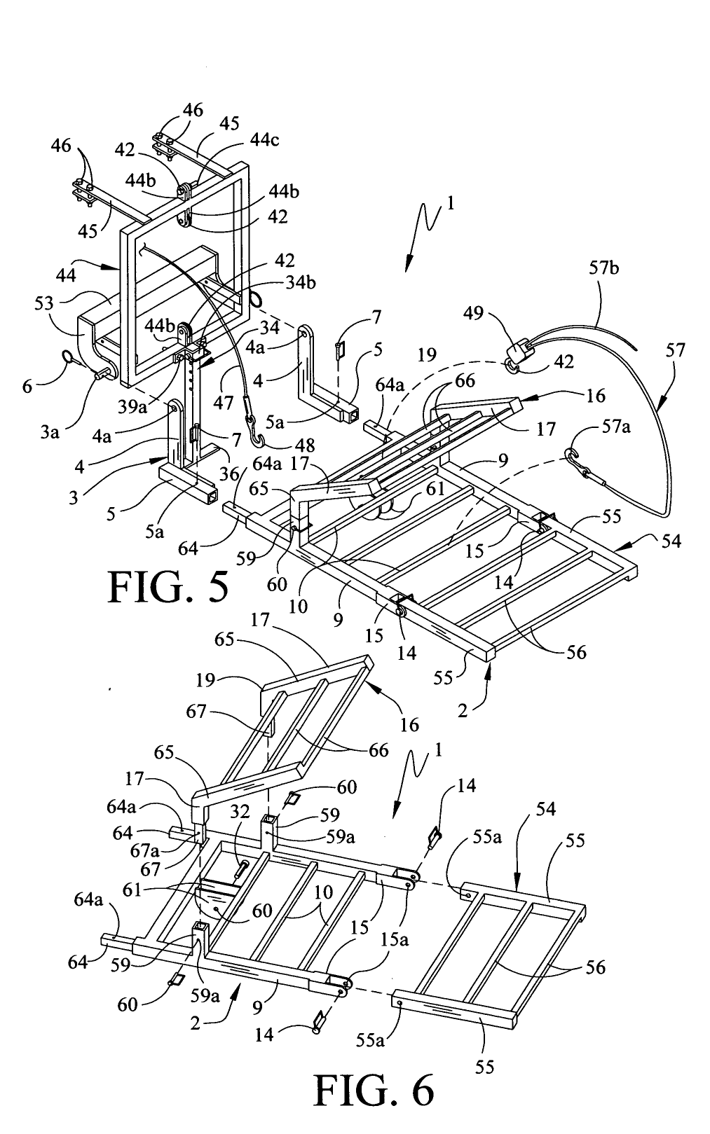

Referring initially to FIGS. 1, 2, 5 and 6 of the drawings, a first embodiment of the game lifting device of this invention is illustrated by reference numeral 1. The game lifting device 1 is characterized by a base or adaptor frame 2, fitted with a pair of L-shaped pivot arms 3 at one end for pivotal attachment to the positioning frame 44 of an all-terrain vehicle (ATV) 40 having wheels 43, as illustrated in FIGS. 1 and 2. In a preferred aspect of this embodiment each of the pivot arms 3 is characterized by an L-shaped arm plate 4, the upper end of which is fitted with an arm plate opening 4a (FIG. 5) and the bottom ends of which receive an adaptor frame mount 5 which is welded or otherwise secured to the lower end of each of the arm plates 4, as further illustrated in FIG. 5 of the drawings. The L-shaped arm plates 4 are each typically characterized by steel flat plate stock and the adaptor frame mounts 5 may be shaped from steel square tubing and each include an adaptor frame mount opening 5a for receiving a base frame mount pin 7, as hereinafter further described.

A pair of fixed arm pivot pins 3a project from the positioning frame 44, which is bolted or otherwise mounted on the ATV 40, typically using a winch frame mount 63, provided on the ATV 40, as further illustrated in phantom in FIGS. 1-4 of the drawings. The respective arm plates 4 of the pivot arms 3 are pivotally mounted on the arm pivot pins 3a by means of corresponding arm plate openings 4a and a pair of arm mount pins 6 removably secure the respective pivot arms 3 on the arm pivot pins 3a, as further illustrated in FIG. 5 of the drawings. An adaptor frame 2 is typically removably secured to the respective adaptor frame mounts 5 of the pivot arms 3 by a pair of extending arm extensions 64, provided on the ends of parallel adaptor frame arms 9, and are sized to insert inside the square tubing base frame mounts 5, as further illustrated in FIG. 5. Each of the arm extensions 64 is provided with an extension opening 64a which aligns with a corresponding adaptor frame mount opening 5a in the two base mount frames 5, to receive an adaptor frame mount pin 7 and removably secure the adaptor frame 2 to the pivot arms 3 (FIG. 5). Accordingly, in a preferred embodiment the adaptor frame 2 is characterized by the pair of parallel, spaced-apart adaptor frame arms 9, connected by multiple, spaced-apart adaptor frame arm spacers 10 and fitted with a pair of fixed upper frame mounts 59 that project upwardly from each of the adaptor frame arms 9, as further illustrated in FIGS. 1-6 of the drawings. An upper frame 16 is disposed above the adaptor frame 2 and in a preferred embodiment, is characterized by a pair of spaced-apart, generally parallel upper frame arms 17, which project upwardly from engagement with each of the upper frame mounts 59 and then forwardly in parallel disposition at upper frame arm bends 65, respectively. The respective upper frame arms 17 are connected by multiple, spaced-apart upper frame arm spacers 66 and are typically removably secured to the upper frame mounts 59 by two upper frame mount pins 60. The upper frame mount pins 60 project through corresponding upper frame mount openings 59a, provided in the upper frame mounts 59, respectively, and the aligned upper frame arm extension openings 67a, provided in a pair of upper frame arm extensions 67, respectively, projecting from the upper frame arms 17 and sized to fit inside the corresponding upper frame mounts 59, as further illustrated in FIG. 6 of the drawings. Accordingly, in a most preferred embodiment of the invention the upper frame 16 is removably secured to the upper frame mounts 59 of the base frame 2 by means of the two upper frame mount pins 60.

As further illustrated in FIGS. 1, 2, 5 and 6 of the drawings a pivoting frame 54 is pivotally secured to the extending end of the adaptor frame 2 at a pair of spaced-apart, vertically oriented arm bifurcations 15, which extend from the free end of the adaptor frame 2. As illustrated in FIG. 6, each of the arm bifurcations 15 is provided with a bifurcation opening 15a, which is designed to align with a corresponding pivoting frame arm opening 55a provided in the one end of each of the pivoting frame arms 55 of the pivoting frame 54. A pivoting frame pin 14 is designed to extend through the aligned bifurcation openings 15a and pivoting frame arm openings 55a, respectively, to pivotally and removably secure the pivoting frame 54 to the end of the adaptor frame 2. In a preferred embodiment of the invention the parallel pivoting frame arms 55 are spaced-apart by pivoting frame arm spacers 56 and the pivoting frame 54 may be selectively pivotally disposed outwardly of the upper frame 16, in substantially longitudinally aligned relationship with respect to the base frame 2 (FIG. 2), or upwardly and rearwardly, toward the upper frame 16 (FIG. 1), as hereinafter further described.

As further illustrated in FIGS. 2 and 5 of the drawings an ATV winch 52, operated by an electric winch motor 52a, is typically mounted on the ATV 40 in conventional fashion and includes a winch cable 47, which is preferably threaded from a winch drum (not illustrated) over a positioning frame pulley 42, typically connected to the positioning frame 44, as illustrated in FIG. 2 of the drawings. The winch cable 47 further typically extends from the winch drum through a conventional set of cable roller guides 51 and includes a winch cable hook 48 on the extending end for engaging a bracket bolt 62, extending through aligned bracket bolt openings 62a provided in a cable mount bracket 61, as illustrated in FIG. 4 of the drawings. Since the cable mount bracket 61 is welded or otherwise secured or fixed to the adaptor frame 2, extension of the winch cable 47 from the drum of the ATV winch 52 by operation of the winch motor 52a lowers the adaptor frame 2 into the loading configuration illustrated in FIG. 2, while reverse operation of the ATV winch 52 applies tension to the winch cable 47, wraps the winch cable 47 on the winch cable drum and raises the adaptor frame 2 substantially to the orientation illustrated in FIG. 1 of the drawings.

Referring now to FIGS. 1, 2 and 5 of the drawings a flexible pivoting frame keeper line 57 is typically provided for engaging the pivoting frame 54 or the adaptor frame 2 and typically, the upper frame 16. The pivoting frame keeper line 57 is typically characterized by a keeper line hook 57a at one end for engaging an adaptor frame arm spacer 10 and a keeper 49 at the other end, provided with a keeper hook 49a for engaging the upper frame 16. A pull line 57b extends through the keeper 49 to facilitate tightening of the pivoting frame keeper line 57, for purposes which will be hereinafter further described. One or more resilient cords such as “bungee cords” may also be used with or as an alternative to the pivoting frame keeper line 57 in this application, as desired.

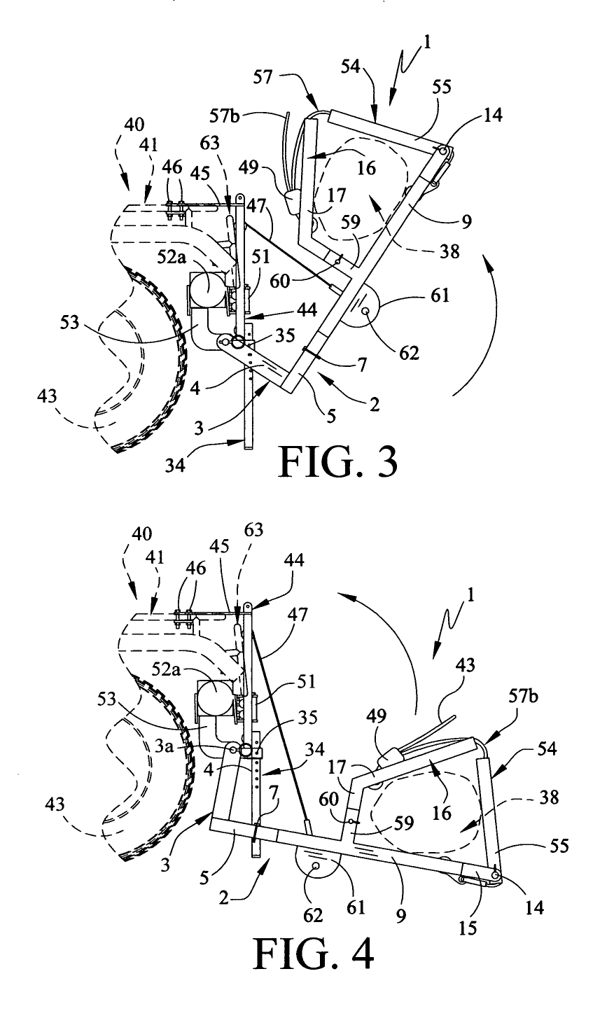

Referring again to FIGS. 1-5 of the drawings, in operation, the game lifting device 1 is operated to lift a load such as the game carcass 38, illustrated in phantom in FIGS. 1, 3 and 4, as follows: under circumstances where it is desired to load the game carcass 38 onto the game lifting device 1, the game lifting device 1 is initially lowered by operation of the ATV winch 52 and winch cable 47 to the position illustrated in FIGS. 2 and 4 of the drawings and the keeper line hook 57a on one end of the pivoting frame keeper line 57 is then removed from the pivoting frame 54 or the adaptor frame 2. Accordingly, the pivoting frame 54 is disposed flat on the ground, substantially in longitudinal alignment with the base frame 2 (FIG. 5) and the game carcass 38 is then rolled or lifted onto the forward portion of the adaptor frame 2 and the pivoting frame 54. The keeper line hook 57a on the pivoting frame keeper line 57 is then re-attached to the pivoting frame 54 or the adaptor frame 2 and the pull line 57b tensioned to tension the pivoting frame keeper line 57 and raise the pivoting frame 54, thereby rolling or sliding the game carcass 38 further onto the front area of the adaptor base frame 2, forwardly of the upper frame mounts. Further tightening of the pivoting frame keeper line 57 secures the game carcass 38 between the upwardly and forwardly-extending upper frame 16 and the now upwardly and rearwardly-pivoted pivoting frame 54, as further illustrated in FIG. 4 of the drawings. The game carcass 38 is thus secured in place by operation of the keeper 49, which maintains tension in the pivoting frame keeper line 57. The adaptor frame 2, upper frame 16 and pivoting frame 54 are then pivoted upwardly in concert on the respective arm pivot pins 3a extending from the positioning frame 44, by operation of the ATV winch 52 and the winch cable 47. When the game lifting device 1 is lifted approximately to the point illustrated in FIGS. 1 and 3 of the drawings, the game carcass 38 may be transported by the ATV 40 while in this carrying configuration. However, in a preferred embodiment of the invention the game lifting device 1 is pivoted past the point illustrated in FIGS. 1 and 3 of the drawings for lengthy transportation purposes.

It will be appreciated by those skilled in the art that while the game lifting device 1 of this embodiment of the invention is illustrated as removably attached to the winch frame of an ATV 40, the device can equally well be supported by a pickup truck or other vehicle having a winch, according to the knowledge of those skilled in the art. Consequently, any vehicle which is fitted with a winch 52 having a winch cable 47 can be modified to receive and utilize the game lifting device 1. It will be further appreciated that while, in a preferred embodiment, the game lifting device 1 is characterized by pivoting arms 3, a base frame 2 and an upper frame 16, as well as a pivoting frame 54, each element of which can be detached and re-assembled using the respective pins as illustrated in FIGS. 5 and 6 of the drawings, these parts or any of them, may equally well be welded or bolted together in a unified frame, as desired.

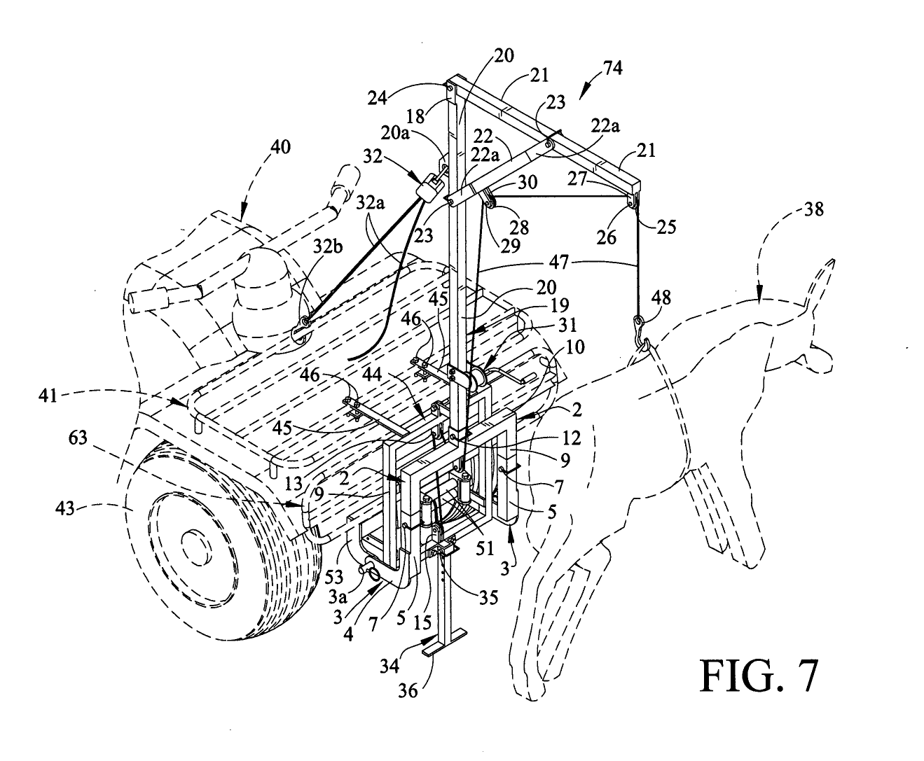

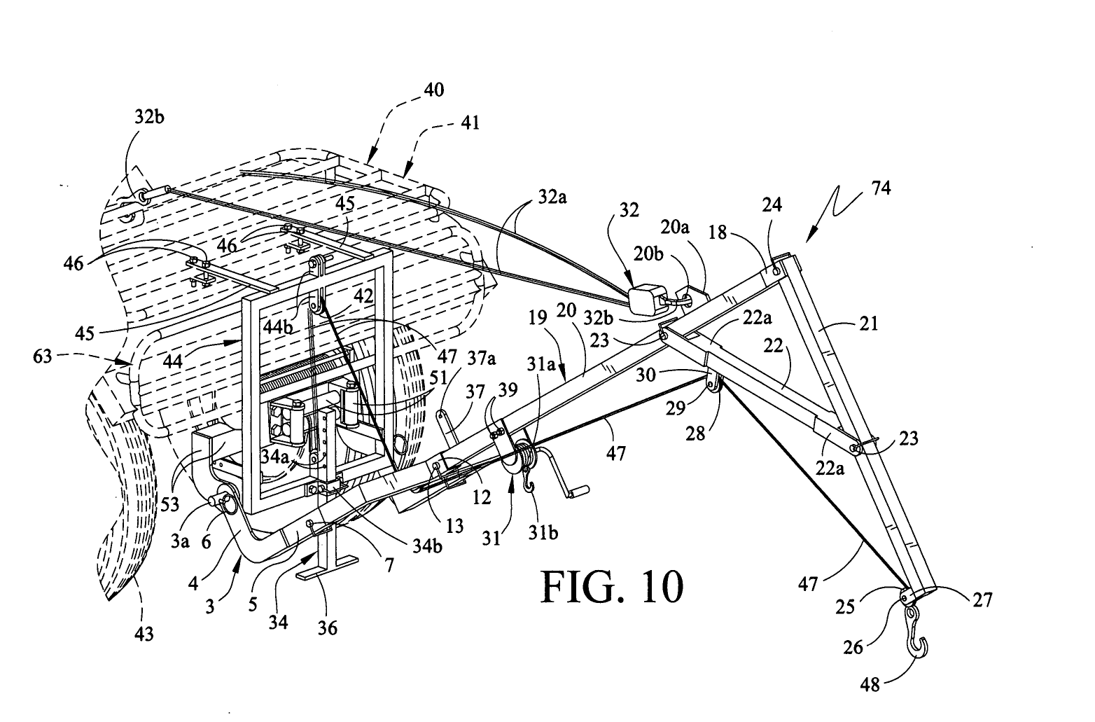

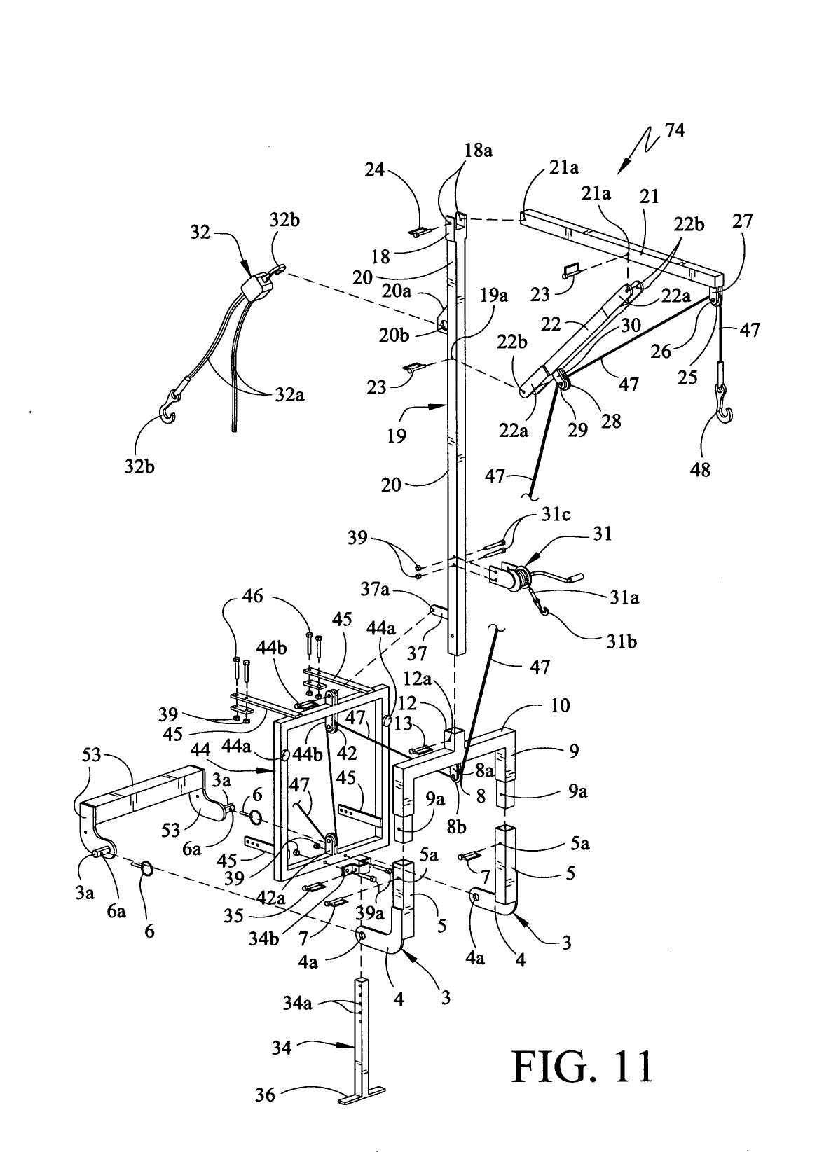

Referring now to FIGS. 7-11 of the drawings, in a second embodiment the game lifting device of this invention is illustrated by reference numeral 74. The game lifting device 74 is characterized by an adaptor frame 2, fitted with a pair of L-shaped pivot arms 3 located at one end for pivotal attachment to a pivot arm bracket 53, mounted on an all-terrain vehicle (ATV) 40, having wheels 43, as illustrated in phantom in FIGS. 7, 8 and 10. In a preferred aspect of this embodiment of the invention each of the pivot arms 3 is characterized by an L-shaped arm plate 4, the bottom end of which is fitted with an arm plate opening 4a (FIG. 11) and the top ends each receiving an adaptor frame mount 5 which is welded or otherwise secured to the arm plates 4, respectively, as further illustrated in FIGS. 7-10 of the drawings. The L-shaped arm plates 4 are each typically characterized by steel flat plate stock and the adaptor frame mounts 5 are preferably, but not necessarily, shaped from steel square tubing. Each of the adaptor frame mounts 5 includes a base frame mount opening 5a (FIG. 11) for receiving an adaptor frame mount pin 7, as heretofore described with respect to the first embodiment of the invention. The respective arm plates 4 of the pivot arms 3 are pivotally mounted on corresponding arm pivot pins 3a extending from the pivot arm bracket 53 by means of the arm plate openings 4a (FIG. 11) and a pair of arm mount pins 6 extend through corresponding arm mount pin openings 6a in the arm pivot pins 3a to removably secure the respective pivot arms 3 on the arm pivot pins 3a, as further illustrated in FIGS. 7-11 of the drawings. A pair of adaptor frame arms 9 are provided in the adaptor frame 2 and are typically removably attached to the respective adaptor frame mounts 5 of the pivot arms 3 by a pair of arm extensions provided on the respective ends of the parallel base frame arms 9, and sized to insert inside the square tubing base frame mounts 5, as further illustrated in FIG. 11. Each of the arm extensions is provided with an adaptor frame arm opening 9a, which aligns with the corresponding base frame mount opening 5a in the two base mount frames 5, respectively, to receive the adaptor frame mount pin 7 and removably secure the adaptor frame 2 to the pivot arms 3 (FIGS. 7-11).

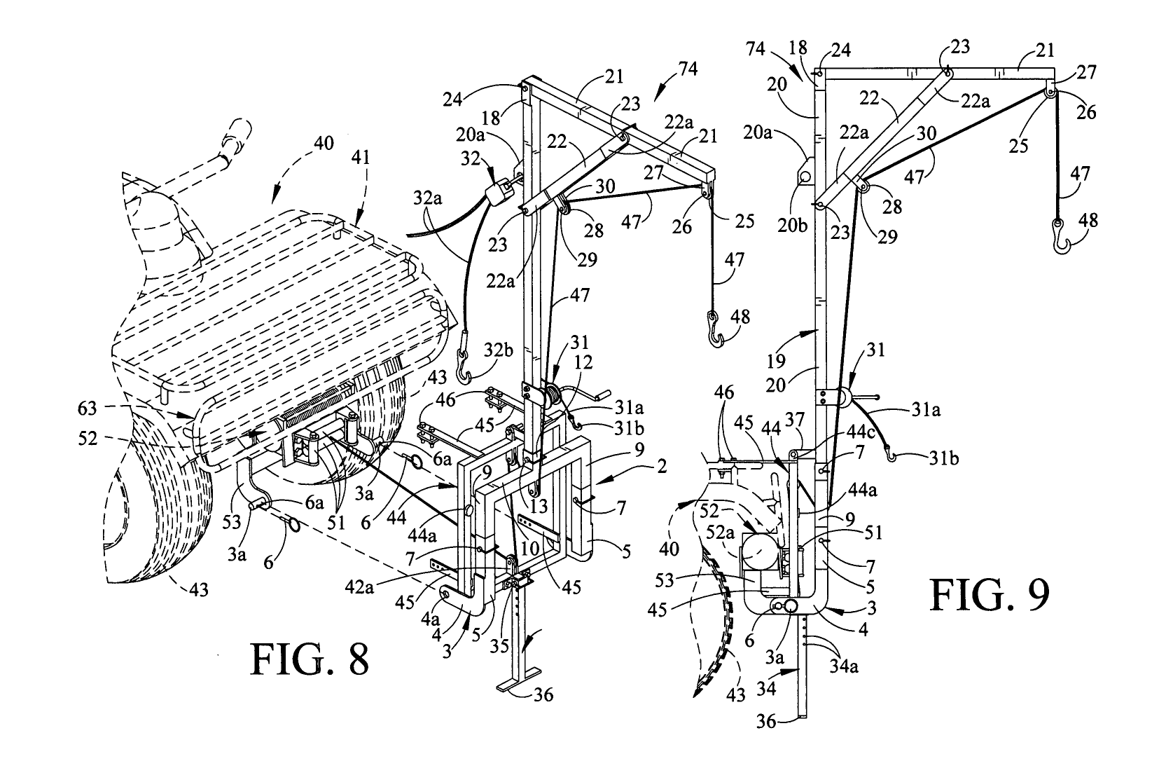

Referring again to FIGS. 8 and 11 of the drawings the adaptor frame arms 9 of the adaptor frame 2 extend from opposite ends of an adaptor frame spacer 10, fitted with a centrally located boom mount 12. The boom mount 12 has a boom mount pin opening 12a (FIG. 11) for receiving a boom mount pin 13 that also extends transversely through the registering boom pin opening 11 in the bottom end of the boom leg 20 of a boom 19. Accordingly, the boom leg 20 is removably attached to the adaptor frame 2 at the boom mount 12 and extends upwardly therefrom to receive a lifting arm 21 at a bifurcated lifting arm bracket 18, as further illustrated in FIGS. 7-11 of the drawings. The generally horizontally-disposed lifting arm 21 is typically provided with a lifting arm support 22 that extends between the lifting arm 21 and the boom 19 at a corresponding pair of support clevis 22a, thus stabilizing the lifting arm 21 in a substantially horizontal configuration for lifting purposes, as hereinafter further described. A pair of lifting arm support pins 23 typically secure the lifting arm support 22 at the clevis openings 22b, to the lifting arm 21 and the boom leg 20 at corresponding boom pin openings 19a (FIG. 11) and lifting arm pin openings 21a, respectively. Furthermore, a lifting arm support pulley 28 is typically secured to the lifting arm support 22 at a lifting arm support pulley mount 30 by means of a lifting arm support pulley pin 29, illustrated in FIGS. 7-11. In similar fashion, a lifting arm pulley 25 is rotatably attached to a corresponding lifting arm pulley mount 27 on a lifting arm pulley pin 26. The lifting arm 21 is typically mounted on the bifurcated lifting arm bracket 18 using a lifting arm pin 24, that extends through registering lifting arm bracket openings 18a and a lifting arm pin opening 21a, as further illustrated in FIG. 11.

Referring to FIGS. 8, 9 and 11 of the drawings, in a preferred embodiment a winch cable 47 extends from an electric ATV winch 52 through the ATV winch cable guide rollers 51 and through a pair of positioning frame pulleys 42, mounted on frame plates 44b, connected to a positioning frame 44 by means of frame plate pins 44c (FIG. 9). The winch cable 47 is extended around an adaptor pulley 8, rotating in an adaptor pulley mount 8a on an adaptor pulley pin 8b, and upwardly around the lifting arm support pulley 28 and lifting arm pulley 25, to a winch cable hook 48. The winch cable hook 48 is designed to engage a load such as a game carcass 38 and lift the game carcass 38 from the ground, responsive to operation of the ATV winch 52, as hereinafter further described. The ATV winch 52 is typically attached to the underside of the ATV 40 in conventional fashion, typically by means of a winch frame (not illustrated). A pair of frame bumpers 44a (FIGS. 8 and 11) are typically mounted on the positioning frame 44 to cushion contact between the positioning frame 44 and the adaptor frame 2.

Referring again to FIGS. 7-11 of the drawings in an alternative preferred embodiment of the invention a boom winch 31 is mounted on the boom leg 20 of the boom 19, typically using boom winch mount bolts 31c and corresponding nuts 39 (FIG. 11). As in the case of the primary electric ATV winch 52, the boom winch 31 is provided with a boom winch cable 31a, fitted with a boom winch cable hook 31b at the end thereof. The boom winch cable 31a is capable of being directed around the lifting arm support pulley 28 and the lifting arm pulley 25, mounted on the lifting arm support 22 and the lifting arm 21, respectively, as illustrated with respect to the winch cable 47 in FIG. 7. The boom winch cable hook 31b can then be attached to the extending end of the boom winch cable 31a and secured to a load such as a game carcass 38 as illustrated in FIG. 7, for lifting the game carcass 38 by hand-operation of the boom winch 31 in conventional fashion.

Furthermore, referring again to FIGS. 7-11 of the drawings, an auxiliary stay 32 may also be utilized for attachment to the boom leg bracket 20a mounted on the boom leg 20 of the boom 19, at a bracket opening 20b to stabilize the boom 19 and the lifting arm 21 in the functional position as illustrated in FIG. 7. The auxiliary stay line 32a is typically provided with two boom winch cable hooks 32b, one of which is attached to the ATV 40 and the other mounted on the boom leg bracket 20a, as described above, after which the cam-operated stay line 32a is tightened in conventional fashion to apply tension to the upward-standing boom leg 20.

In yet another preferred aspect of this embodiment of the invention, a frame leg 34 is typically secured to the lower horizontal leg of the positioning frame 44 at a frame leg bracket 34b, using bracket bolts 39a and corresponding nuts 39 (FIGS. 7 and 11). The function of the frame leg 34a is to provide a support for the front end of the ATV when a load such as a game carcass 38 is applied to the winch cable 47, such that the toe plate 36, mounted on the extending downward end of the frame leg 34, touches the ground and prevents the front end of the ATV 40 from depressing downwardly due to the load. In a preferred embodiment adjusting holes 34a are provided in the frame leg 34 for adjusting the distance of the toe plate 36 from the ground, as a frame leg pin 35 (FIG. 11) is extended through selected ones of the frame leg adjusting holes 34a and the corresponding spaced-apart openings in the frame leg bracket 34b.

It will be appreciated from a consideration of FIGS. 7-11 that the positioning frame 44 is typically attached to the ATV 40 by four frame mount straps 45, two of which are attached to the top rack 41 of the ATV 40, typically by means of strap bolts 46 and corresponding nuts 39. The remaining two frame mount straps 45 are welded or otherwise securely attached to the bottom end of the positioning frame 44 and are bolted to the underside of the ATV frame in a similar manner.

Referring again to FIGS. 8 and 11 of the drawings, under circumstances where it is desired to remove the boom 19 from the adaptor frame 2, the boom mount pin 13 is initially removed from the corresponding boom mount 12 and bottom end of the boom leg 20 and the boom strap 37 is disconnected from the frame plates 44b on the positioning frame 44, after which the boom 19 is lifted from the boom mount 12. The winch cable 47 is typically re-wound on the ATV winch 52 after removing the winch cable hook 48 from the end thereof, in conventional fashion. Alternatively, if the boom winch 31 is in service rather than the primary electric winch 52 mounted on the ATV 40, the boom winch cable hook 31b is removed from the extending end of the boom winch cable 31a and the boom winch cable 31a then manually wound on the boom winch 31 before removing the boom 19 from the adaptor frame 2. The adaptor frame 2 can then be removed from the front end of the ATV 40 by removing the two arm mount pins 6 from the corresponding arm pivot pins 3a and disengaging the corresponding arm plates 4 from the arm pivot pins 3a. The positioning frame 44 can also be quickly and easily removed from the ATV 40 by loosening the nuts 39 and removing the respective strap bolts 46 from the corresponding frame mount straps 45.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A load-lifting device for mounting on a vehicle having a winch and a winch cable, comprising an adaptor frame pivotally carried by the vehicle, said adaptor frame attached to the winch cable for selectively raising and lowering said adaptor frame responsive to operation of the winch; an upper frame upward-standing from said adaptor frame; and a pivoting frame pivotally carried by said adaptor frame for selectively extending outwardly of said adaptor frame and receiving a load, and pivoting upwardly toward said upper frame for securing the load on said adaptor frame.

2. The load-lifting device of claim 1 comprising a positioning frame connected to the vehicle and at least one pulley carried by said positioning frame, wherein the winch cable engages said pulley and extends to said adaptor frame.

3. The load-lifting device of claim 1 comprising a flexible keeper line attached to said upper frame and engaging said pivoting frame for securing the load on said adaptor frame between said upper frame and said pivoting frame.

4. The load-lifting device of claim 1 comprising:
(a) a positioning frame connected to the vehicle and at least one pulley carried by said positioning frame, wherein the winch cable engages said pulley and extends to said adaptor frame; and
(b) a flexible keeper line attached to said upper frame and engaging said pivoting frame for securing the load on said adaptor frame between said upper frame and said pivoting frame.

5. The load-lifting device of claim 1 comprising a pivot arm bracket carried by the vehicle and a pair of pivot arms provided on said adaptor frame, said pivot arms pivotally engaging said pivot arm bracket for pivotally mounting said adaptor frame on said positioning frame.

6. The load-lifting device of claim 1 comprising:
(a) a positioning frame connected to the vehicle and at least one pulley carried by said positioning frame, wherein the winch cable engages said pulley and extends to said adaptor frame;
(b) a flexible keeper line attached to said upper frame and engaging said pivoting frame for securing the load on said adaptor frame between said upper frame and said pivoting frame; and
(c) a pivot arm bracket carried by the vehicle and a pair of generally L-shaped pivot arms provided on said adaptor frame, said pivot arms pivotally engaging said pivot arm bracket for pivotally mounting said adaptor frame on said pivot arm bracket.

7. The load-lifting device of claim 5 comprising a positioning frame carried by the vehicle and at least one pulley carried by said positioning frame, wherein the winch cable engages said pulley and extends to said adaptor frame.

8. The load-lifting device of claim 1 comprising a first set of connecting members removably engaging said adaptor frame and said upper frame for removably connecting said upper frame to said adaptor frame.

9. The load-lifting device of claim 1 comprising a second set of connecting members removably engaging said adaptor frame and said pivoting frame for removably connecting said pivoting frame to said adaptor frame.

10. The load-lifting device of claim 5 comprising:
(a) a set of pivot arm connecting members removably engaging said adaptor frame and said pivot arms for removably connecting said pivot arms to said adaptor frame;
(b) a first set of connecting members removably engaging said adaptor frame and said upper frame for removably connecting said upper frame to said adaptor frame; and
(c) a second set of connecting members removably engaging said adaptor frame and said pivoting frame for removably connecting said pivoting frame to said adaptor frame.

11. The load-lifting device of claim 10 comprising a positioning frame connected to the vehicle and at least one pulley carried by said positioning frame, wherein the winch cable engages said pulley and extends to said adaptor frame.

12. The load-lifting device of claim 10 comprising a flexible keeper line attached to said upper frame and engaging said pivoting frame for securing the load on said adaptor frame between said upper frame and said pivoting frame.

13. The load-lifting device of claim 10 comprising:
(a) a positioning frame connected to the vehicle and at least one pulley carried by said positioning frame, wherein the winch cable engages said pulley and extends to said adaptor frame; and
(b) a flexible keeper line attached to said upper frame and engaging said pivoting frame for securing the load on said adaptor frame between said upper frame and said pivoting frame.

14. A device for lifting and transporting a load using an all-terrain vehicle having a winch and a winch cable provided on the winch, comprising a pair of pivot arms pivotally connected to the all-terrain vehicle; an adaptor frame carried by said pivot arms and connected to the winch cable; an upper frame provided on said adaptor frame; and a pivoting frame pivotally connected to said adaptor frame, wherein the load is placed on said adaptor frame and said pivoting frame responsive to operation of the winch and lowering of said adaptor frame, and the load is raised for transporting responsive to pivoting of said pivoting frame toward said upper frame and reverse-operation of the winch.

15. The device of claim 14 comprising a keeper line attached to said upper frame and engaging said pivoting frame for securing the load on said adaptor frame between said upper frame and said pivoting frame.

16. The device of claim 14 wherein said upper frame extends upwardly from said adaptor frame and forwardly toward said pivoting frame.

17. The device of claim 16 comprising a keeper line attached to said upper frame and engaging said pivoting frame for securing the load on said adaptor frame between said upper frame and said pivoting frame.

18. The device of claim 16 comprising a set of pivot arm pins removably engaging said adaptor frame and said pivot arms for removably connecting said pivot arms to said adaptor frame; a set of upper frame arm pins removably engaging said adaptor frame and said upper frame for removably connecting said upper frame to said adaptor frame; and a set of pivoting frame pins removably engaging said adaptor frame and said pivoting frame for removably connecting said pivoting frame to said adaptor frame.

19. A game carcass lifting and transporting device for mounting on an all-terrain vehicle having a winch and a winch cable mounted on a winch frame connected to the all-terrain vehicle, said game carcass lifting and transporting device comprising a positioning frame and a pivot arm bracket attached to the all-terrain vehicle; pair of generally L-shaped pivot arms having one end thereof pivotally attached to said pivot arm bracket rearwardly of said positioning frame; an adaptor frame having one end attached to the opposite end of said pivot arms from said one end of said pivot arms, respectively; at least one pulley carried by said positioning frame for receiving said winch cable and guiding said winch cable for attachment to said adaptor frame; an upper frame extending upwardly and forwardly from said adaptor frame; and a pivoting frame pivotally connected to the opposite end of said adaptor frame from said one end of said adaptor frame, wherein the game carcass is positioned on said adaptor frame and said pivoting frame responsive to lowering of said adaptor frame, said upper frame and said pivoting frame by operation of the winch in a first direction, and the game carcass is raised into a transporting configuration responsive to pivoting of said pivoting frame toward said upper frame and operation of the winch in a second direction.

20. The game carcass lifting and transportation device of claim 19 comprising a keeper line attached to said upper frame and engaging said pivoting frame for securing the game carcass on said adaptor frame between said upper frame and said pivoting frame.

21. A load-lifting device for mounting on a vehicle having a winch and a winch cable, comprising an adaptor frame pivotally carried by the vehicle; a boom upward-standing from said adaptor frame; and a lifting arm carried by said boom and extending outwardly of said boom, said lifting arm receiving the winch cable for raising and lowering a load responsive to operation of the winch.

22. The load-lifting device of claim 21 comprising at least one pulley connected to said lifting arm, wherein the winch cable engages said pulley for said raising and lowering of the load.

23. The load-lifting device of claim 21 comprising an auxiliary stay attached to said boom and the vehicle for stabilizing said boom and said lifting arm for said raising and said lowering of the load.

24. The load-lifting device of claim 21 comprising:
(a) at least one pulley connected to said lifting arm, wherein the winch cable engages said pulley for said raising and lowering of the load; and
(b) an auxiliary stay attached to said boom and the vehicle for stabilizing said boom and said lifting arm for said raising and said lowering of the load.

25. The load-lifting device of claim 21 comprising a lifting arm support provided on said boom and said lifting arm for supporting said lifting arm during said raising and lowering of the load.

26. The load-lifting device of claim 21 comprising:
(a) at least one pulley connected to said lifting arm, wherein the winch cable engages said pulley for said raising and lowering of the load;
(b) a flexible auxiliary stay attached to said boom and the vehicle for stabilizing said boom and said lifting arm for said raising and said lowering of the load; and
(c) a lifting arm support provided on said boom and said lifting arm for supporting said lifting arm during said raising and lowering of the load.

27. The load-lifting device of claim 25 comprising a first connecting member removably engaging said adaptor frame and said boom for removably connecting said boom to said adaptor frame.

28. The load-lifting device of claim 27 comprising a lifting arm support provided on said boom and said lifting arm for supporting said lifting arm during said raising and lowering of the load, a first pulley connected to said lifting arm support and a second pulley connected to said lifting arm, wherein the winch cable engages said first pulley and said second pulley for said raising and lowering of the load.

29. The load-lifting device of claim 27 comprising a flexible auxiliary stay attached to said boom and the vehicle for stabilizing said boom and said lifting arm for said raising and said lowering of the load.

30. The load-lifting device of claim 27 comprising:
(a) a lifting arm support provided on said boom and said lifting arm for supporting said lifting arm during said raising and lowering of the load, a first pulley connected to said lifting arm support and a second pulley connected to said lifting arm, wherein the winch cable engages said first pulley and said second pulley for said raising and lowering of the load; and
(b) a flexible auxiliary stay attached to said boom and the vehicle for stabilizing said boom and said lifting arm for said raising and said lowering of the load.

31. A device for lifting and transporting a load using an all-terrain vehicle having a winch and a winch cable provided on the winch, comprising a pair of pivot arms pivotally and removably connected to the all-terrain vehicle; an adaptor frame carried by said pivot arms and receiving the winch cable; a boom removably engaging said adaptor frame; and a lifting arm connected to said adaptor frame and receiving the winch cable, wherein the load is placed on the winch cable and the load is raised and lowered responsive to operation of the winch.

32. The device of claim 31 comprising an auxiliary stay attached to said boom and the vehicle for stabilizing said boom and said lifting arm for said raising and said lowering of the load.

33. The device of claim 31 comprising a frame leg carried by the vehicle for engaging a supporting surface when the load is placed on the winch cable and raised and lowered responsive to operation of the winch.

34. The device of claim 33 comprising a flexible auxiliary stay attached to said boom and the vehicle for stabilizing said boom and said lifting arm for said raising and said lowering of the load.

35. A game carcass lifting device for mounting on an all-terrain vehicle, said game carcass lifting device comprising a pair of generally L-shaped pivot arms having one end thereof pivotally attached to the all-terrain vehicle; an adaptor frame having one end attached to the opposite end of said pivot arms from said one end of said pivot arms, respectively; a boom extending upwardly from said adaptor frame; a winch mounted on said boom and a winch cable provided on said winch; and a lifting arm connected to the opposite end of said adaptor frame from said one end of said adaptor, wherein the game carcass is attached to the winch cable responsive to lowering of the winch cable by operation of the winch in a first direction, and the game carcass is raised into a dressing configuration responsive to attaching of the winch cable to the game carcass and operation of the winch in a second direction.

36. The game carcass lifting device of claim 35 comprising a flexible auxiliary stay attached to said boom and the vehicle for stabilizing said boom and said lifting arm for said raising and said lowering of the load.

37. The game carcass lifting device of claim 35 comprising at least one pulley connected to said lifting arm, wherein the winch cable engages said pulley for said raising and lowering of the load.

38. The game carcass lifting device of claim 35 comprising a frame leg carried by the vehicle for engaging a supporting surface when the load is placed on the winch cable and raised and lowered responsive to operation of the winch.

39. The game carcass lifting device of claim 35 comprising a lifting arm support provided on said boom and said lifting arm for supporting said lifting arm during said raising and lowering of the load.

40. The game carcass lifting device of claim 38 comprising a lifting arm support provided on said boom and said lifting arm for supporting said lifting arm during said raising and lowering of the load, a first pulley connected to said lifting arm support and a second pulley connected to said lifting arm, wherein the winch cable engages said first pulley and said second pulley for said raising and lowering of the load.
